(19) United States
(12) Patent Application Publication
(10) Pub. No.: US 2006/0021697 A1
(43) Pub. Date: Feb. 2, 2006

(54) Member for reinforcing, sealing or baffling and reinforcement system formed therewith

(75) Inventors: Jon Riley, Farmington, MI (US); David Carlson, Rochester Hills, MI (US); Greg Skvorfskolf, Ontario (CA); David Read, Mississauga (CA)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/189,190

(22) Filed: Jul. 26, 2005

Related U.S. Application Data
(60) Provisional application No. 60/592,691, filed on Jul. 30, 2004.

(51) Int. Cl. B29C 65/48

(52) U.S. Cl. 156/295

(57) ABSTRACT

A member is provided for reinforcing, sealing or baffling structures of articles of manufacture such as automotive vehicles. The member typically includes a carrier member at least partially formed of a metal material and having a cellular structure. The member also typically includes an expandable material disposed on the carrier member.

### CLAIM OF PRIORITY

This application claims the benefit of the filing date of U.S. Provisional Application No. 60/592,691 filed Jul. 30, 2004.

### TECHNICAL FIELD

The present invention relates to a member, which is employed for providing reinforcing, sealing, baffling, combinations thereof or the like to a structure of an article of manufacture such as an automotive vehicle. More particularly, the present invention relates to a reinforcement member that is at least partially formed of a metal foam (e.g., includes an aluminum foam carrier).

### BACKGROUND

For many years, industries such as the transportation industry have been innovatively designing members for enhancing structural reinforcement, damping, sealing, baffling, thermal insulation and acoustic absorption characteristics of articles such as furniture, buildings and transportation vehicles (e.g., automotive vehicles, boats, trains, busses, airplanes or the like). Design of such members can involve several different considerations, and these considerations may need to be balanced against one another to achieve a desired result. Examples of such considerations include, without limitation, strength, stiffness, weight, and cost of the members. Other considerations include compatibility of the members with articles of manufacture, ease of assembling the members to articles of manufacture, ability of the members to provide desired levels of damping, reinforcement or sealing or other like considerations.

In the interest of continuing such innovation, the present invention provides an improved member suitable for providing baffling, sealing, reinforcing, a combination thereof or the like to a structure of an article of manufacture.

### SUMMARY OF THE INVENTION

Accordingly, a reinforcement member is provided along with a process of forming and applying the reinforcement member to a structure of an article of manufacture such as an automotive vehicle. The reinforcement member typically includes a carrier with expandable material disposed upon the carrier. The carrier is typically formed of a metal material and preferably include an internal cellular portion surrounded by a relatively thicker skin. In one preferred embodiment, the carrier is formed of aluminum, magnesium or both using a low pressure molding or casting technique.

### BRIEF DESCRIPTION OF THE DRAWINGS

FIG. 1 illustrates a perspective view of an exemplary reinforcement member formed in accordance with an aspect of the present invention.

FIG. 2 illustrates a sectional view of the exemplary reinforcement member taken along line 2-2.

FIG. 3 illustrates an exemplary application of the reinforcement member of FIG. 1 to a structure of an automotive vehicle in accordance with an aspect of the present invention.

### DETAILED DESCRIPTION OF THE INVENTION

The present invention is predicated upon the provision of an improved member for sealing, baffling or reinforcing a structure of an article of manufacture. The present invention also provide a method of making the improved member, a method of using the improved member and a system formed thereby. Although it is contemplated that the member may be employed in a variety of articles of manufacture, for exemplary purposes, the member is discussed herein as being employed in an automotive vehicle. The process for forming the member and for applying the member to an automotive vehicle preferably includes one or a combination of the following steps:
i) providing a metal material such as aluminum, aluminum alloy or aluminum based metal matrix composite typically in a molten or partially molten state;
ii) shaping (e.g., extruding, casting or molding) the metal material to form a carrier member, the carrier member having a cellular structure;
iii) applying an expandable material to a surface of the carrier member for forming the member, typically a reinforcement member;
iv) placing the member within a cavity of an automotive vehicle, the cavity being defined by one or more walls of a structure of the automotive vehicle; and
v) activating the expandable material to form a structural foam that is adhered to the carrier member and the one or more walls of the structure of the automotive vehicle for forming a reinforced structural system.

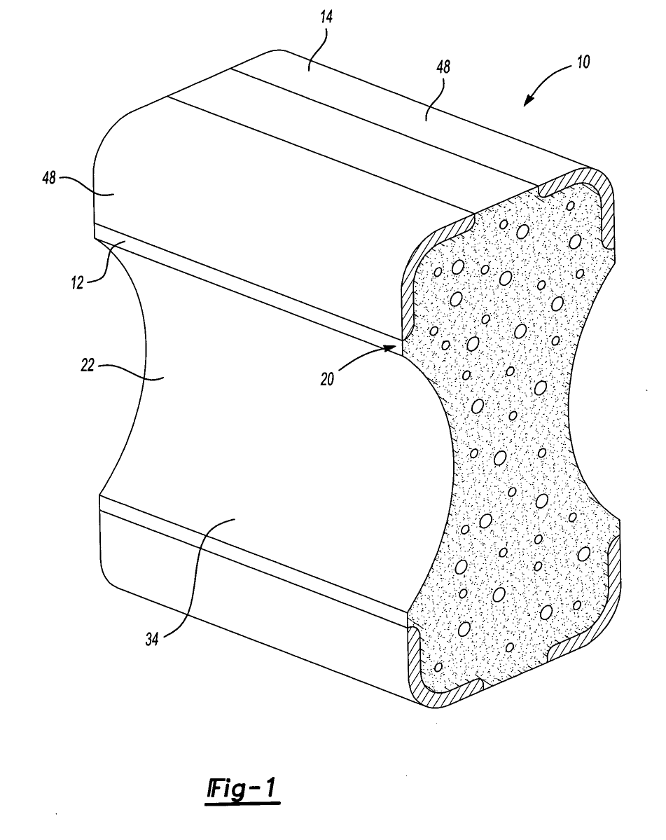

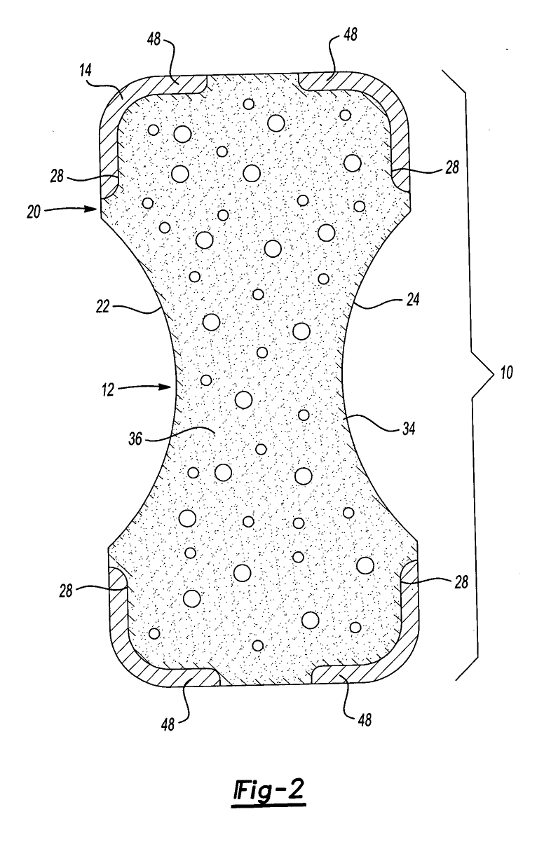

For exemplary purposes, FIGS. 1 and 2 illustrate a reinforcement member 10 formed in accordance with an aspect of the present invention. The reinforcement member 10 includes a carrier member 12 and an expandable material 14 disposed upon the carrier member 12.

Material for the Carrier Member

The carrier member is typically formed of a metal material, which may include any metal such as tin, steel, aluminum, magnesium, iron, a combination thereof or the like. The metal material may also include a variety of additional materials such as fillers, fibers, metal matrix composite (MMC), refractory particles, stabilizers, combinations thereof or the like. Typically, the metal material for the carrier member is at least 70% metal, more typically at least 85% metal and even more typically at least 92% metal. In a preferred embodiment, the metal material is at least 65% aluminum, more typically at least 80% aluminum and even more typically at least 90% aluminum.

Casting or Molding the Metal Material into the Carrier Member

It is contemplated that the carrier member may be formed, shaped or both according to a variety of techniques such as molding, casting, extruding, stamping, combinations thereof or the like. It is preferable, however, for the carrier member to be formed or shaped via a casting process such as low pressure aluminum casting. In a highly preferred embodiment, the carrier member is molded such that it has a cellular structure, which may be internal, external or both.

According to one embodiment, the metal material is low pressure foam cast to produce and shape the carrier member. Examples of molding processes, which provide cellular structures in metal materials are disclosed in PCT Publications WO 03/015960 A1 or A2 and WO 01/62416 A1, both of which are expressly incorporated by reference for all purposes. In such a process, the metal material, typically an aluminum material or mixture of aluminum and other materials or metals, is provided in a bath in a molten state. A riser tube is at least partially submerged into the molten metal material and the riser tube is preferably connected to and provides fluid communication with a casting die that defines a die cavity. Pressure is typically applied to the molten metal material in the bath such that the molten metal material rises through the riser tube into the die cavity. While the molten metal material is in the die cavity, a gas is typically bubbled through the metal material and the metal material is cooled such that it hardens into an aluminum foam and forms the carrier member into the shape of the die cavity.

Typically, the carrier member can be shaped according to the casting process or according to other processes to have nearly any desired external surface shape and can also be internally shaped for example by using inserts within the die. For exemplary purposes, the carrier member 12 of FIGS. 1 and 2 has been cast to have an external surface 20 that defines a first concave arcuate surface 22 and a second concave arcuate surface 24. Moreover, the external surface 20 includes multiple cavities 28 for receiving the expandable material 14.

Metal or aluminum foam casting of the carrier member will typically form a skin at it periphery defining the outer surfaces of the carrier member or at any surface formed by inserts within the casting die. As used herein, the skin is a substantially continuous layer of the metal material overlaying at least a section of foamed or cellular metal material. Moreover, such skin typically substantially encapsulates the inner portion of the carrier member, which is formed of aluminum or metal foam, although not required. As shown in FIGS. 1 and 2, a skin 34 is formed at the outer periphery of the carrier member 12 and the skin 34 defines the external surface 20 and substantially encapsulates an inner portion 36 of the carrier member 12. Advantageously, it has been discovered that the thickness of the skin can be controlled for providing desired characteristics such as strength to the carrier member. Moreover, it has been discovered that the average density of the inner portion of the carrier member can also be controlled to control the weight of the carrier member.

In one embodiment, at least 50%, more typically at least 70% and more typically at least 90% of any skin formed in or upon the carrier member is at least 0.03 mm, more typically at least 0.06 mm, more typically at least 0.1 mm, even more typically at least 0.3 mm, even more typically at least 0.7 mm, still more typically at least 1.2 mm and still more typically at least 2.0 mm thick. In this embodiment or another embodiment, the average density of the entire inner portion of the carrier member is typically less than 1 g/cm³, more typically less than 0.7 g/cm³, even more typically less than 0.5 g/cm³ and still more typically less than 0.36 g/cm³. Of course, these figures may be higher or lower unless otherwise specifically stated.

Generally, it is contemplated that various method or techniques may be employed for controlling the thickness of the skin of the carrier member. One method of controlling the thickness of the skin formed upon the carrier member is by controlling factors such as temperature of the molten metal, temperature of the casting die or mold, pressure applied to the molten metal, shape of the casting die or mold, amount and method of supplying bubbles to the molten metal and/or the casting die, amount of time of formation of the carrier member, cooling or solidification rate of the molten metal, injection rate of the molten metal in the die or mold, combinations thereof or the like. In one exemplary embodiment, the skin is formed by having the casting die or mold at a first temperature that is typically lower than a second temperature of the molten metal when the molten metal is initially supplied to the casting die or mold. In this manner, the skin is quickly formed as the molten metal contacts the cooler surface of the die or mold. In such and embodiment, the second temperature is typically at least 10% greater, more typically at least 40% greater and even more typically at least 100% greater (i.e., twice the temperature of the first temperature) than the first temperature.

Generally it is contemplated that the outer surface of the carrier may include or be roughened or textured for allowing the expandable material to adhere to the surface with greater strength. In one embodiment, the casting die or mold may be roughened or textured such that the carrier, the skin or both having a corresponding roughness or texture upon formation of the carrier. In another embodiment, the carrier may be formed or shaped and the outer surface may be subsequently roughened (e.g., by sanding or other technique).

Applying Expandable Material to the Carrier Member to Form a Reinforcement Member

When used in automotive vehicles or other articles of manufacture, it is preferable for an expandable material to be applied to the carrier member of the invention for forming a reinforcement member or a member for sealing or baffling. In FIGS. 1 and 2, the expandable material 14 is disposed upon the outer surface 20 of the carrier member 12 for forming the reinforcement member 10. In particular, the expandable material 14 is at least partially disposed within the cavities 28 formed in the carrier member 12. It is contemplated, however, that the expandable material may be placed in nearly any configuration upon any surface of any carrier member formed in accordance with the present invention.

The expandable material may be formed of several different materials. Generally speaking, the member may utilize technology and processes for the forming and applying the expandable material such as those disclosed in U.S. Pat. Nos. 4,922,596, 4,978,562, 5,124,186, and 5,884,960 and commonly owned, co-pending U.S. application Ser. No. 09/502,686 filed Feb. 11, 2000 and Ser. No. 09/524,961 filed Mar. 14, 2000, and U.S. Application attorney docket No. 1001-141, filed Jun. 15, 2004, all of which are expressly incorporated by reference for all purposes. Typically, when used for reinforcement, the expandable material is formed of a high compressive strength and stiffness heat activated reinforcement material having foamable characteristics. The material may be generally dry to the touch or tacky and can be placed upon the carrier member or the like in any form of desired pattern, placement, or thickness, but is preferably of substantially uniform thickness. One exemplary expandable material is L-5204 structural foam available through L&L Products, Inc. of Romeo, Mich.

Though other heat-activated materials are possible for the expandable material, a preferred heat activated material is an expandable polymer or plastic, and preferably one that is foamable. A particularly preferred material is an epoxy-based structural foam. For example, and without limitation, the structural foam may be an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of epoxy-based structural reinforcing or sealing foams are known in the art and may also be used to produce the structural foam. A typical structural foam includes a polymeric base material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material or a thermoset material, the structural foam is usually initially processed as a flowable thermoplastic material before curing. Such a material will typically cross-link upon curing, which makes the material incapable of further flow.

An example of a preferred structural foam formulation is an epoxy-based material that is commercially available from L&L Products of Romeo, Mich., under the designations L5206, L5207, L5208, L5209. One advantage of the preferred structural foam materials over prior art materials is that the preferred materials can be processed in several ways. The preferred materials can be processed by injection molding, extrusion compression molding, overmolding onto a carrier or with a mini-applicator. This enables the formation and creation of part designs that exceed the capability of most prior art materials. In one preferred embodiment, the structural foam (in its uncured state) generally is dry or relatively free of tack to the touch and can easily be attached to the carrier member through fastening means which are well known in the art.

While the preferred materials for fabricating the expandable material have been disclosed, the expandable material can be formed of other materials provided that the material selected is heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. See also, U.S. Pat. Nos. 5,766,719; 5,755,486; 5,575,526; and 5,932,680, (incorporated by reference). In general, the desired characteristics of the expandable material include relatively high stiffness, high strength, high glass transition temperature (typically greater than 70 degrees Celsius), and adhesion durability properties. In this manner, the material does not generally interfere with the materials systems employed by automobile manufacturers. Exemplary materials include materials sold under product designation L5207 and L5208, which are commercially available from L & L Products, Romeo, Mich.

It is also contemplated that, when the member of the present invention is used for sealing or baffling, the expandable material may be designed to absorb or attenuate sound, block off and prevent passage of materials through a cavity or the like. As such, the expandable material may be configured to expand to greater than a volume that is at least 200%, at least 400%, at least 800%, at least 1600% or even at least 3000% or its original unexpanded volume. Examples of such expandable material are discussed in U.S. Application attorney docket No. 1001-141, filed Jun. 15, 2004, expressly incorporated by reference.

In applications where the expandable material is a heat activated, thermally expanding material, an important consideration involved with the selection and formulation of the material comprising the structural foam is the temperature at which a material reaction or expansion, and possibly curing, will take place. For instance, in most applications, it is undesirable for the material to be reactive at room temperature or otherwise at the ambient temperature in a production line environment. More typically, the structural foam becomes reactive at higher processing temperatures, such as those encountered in an automobile assembly plant, when the foam is processed along with the automobile components at elevated temperatures or at higher applied energy levels, e.g., during paint curing steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the composition to cause expansion at different temperatures outside the above ranges.

Generally, suitable expandable foams have a range of expansion ranging from approximately 0 to over 1000 percent. The level of expansion of the expandable material 30 may be increased to as high as 1500 percent or more. Typically, strength and stiffness are obtained from products that possess lower expansion.

Some other possible materials for the expandable material include, but are not limited to, polyolefin materials, copolymers and terpolymers with at least one monomer type an alpha-olefin, phenol/formaldehyde materials, phenoxy materials, and polyurethane. See also, U.S. Pat. Nos. 5,266,133; 5,766,719; 5,755,486; 5,575,526; 5,932,680; and WO 00/27920 (PCT/US 99/24795) (all of which are expressly incorporated by reference). In general, the desired characteristics of the resulting material include relatively low glass transition point, and good adhesion durability properties. In this manner, the material does not generally interfere with the materials systems employed by automobile manufacturers. Moreover, it will withstand the processing conditions typically encountered in the manufacture of a vehicle, such as the e-coat priming, cleaning and degreasing and other coating processes, as well as the painting operations encountered in final vehicle assembly.

In another embodiment, the expandable material is provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

In addition, as discussed previously, preformed patterns may also be employed such as those made by extruding a sheet (having a flat or contoured surface) and then die cutting it according to a predetermined configuration in accordance with the chosen pillar structure, door beam, carrier member or the like, and applying it to thereto.

The skilled artisan will appreciate that the system may be employed in combination with or as a component of a conventional sound blocking baffle, or a vehicle structural reinforcement system, such as is disclosed in commonly owned co-pending U.S. application Ser. No. 09/524,961 or 09/502,686 (hereby incorporated by reference).

It is contemplated that the material of the expandable material could be delivered and placed into contact with the assembly members, through a variety of delivery systems which include, but are not limited to, a mechanical snap fit assembly, extrusion techniques commonly known in the art as well as a mini-applicator technique as in accordance with the teachings of commonly owned U.S. Pat. No. 5,358,397 (“Apparatus For Extruding Flowable Materials”), hereby expressly incorporated by reference. In this non-limiting embodiment, the material or medium is at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) wherein the foamable or expandable material can be snap-fit onto the chosen surface or substrate; placed into beads or pellets for placement along the chosen substrate or member by means of extrusion; placed along the substrate through the use of baffle technology; a die-cast application according to teachings that are well known in the art; pumpable application systems which could include the use of a baffle and bladder system; and sprayable applications.

Installing the Reinforcement Member to an Automotive Vehicle

Once completed, the reinforcement member of the present invention is preferably installed to an automotive vehicle although it may be employed for other articles of manufacture such as boats, buildings, furniture, storage containers or the like. The reinforcement member may be used to reinforce a variety of components of an automotive vehicle including, without limitation, body components (e.g., panels), frame components (e.g., hydroformed tubes), pillar structures (e.g., A, B or C-pillars), bumpers, roofs or the like of the automotive vehicle.

In one preferred embodiment, the reinforcement member is placed at least partially within a cavity of a structure of an automotive vehicle wherein the cavity is defined by one or more walls or surfaces of the structure. Thereafter, the expandable material is activated to expand, wet, and adhere to one or more surfaces of the carrier member and one or more surfaces of the component of the automotive vehicle. Upon curing, the expandable material preferably forms a rigid structural foam securing the reinforcement member within the cavity of the structure of the vehicle thereby reinforcing the structure.

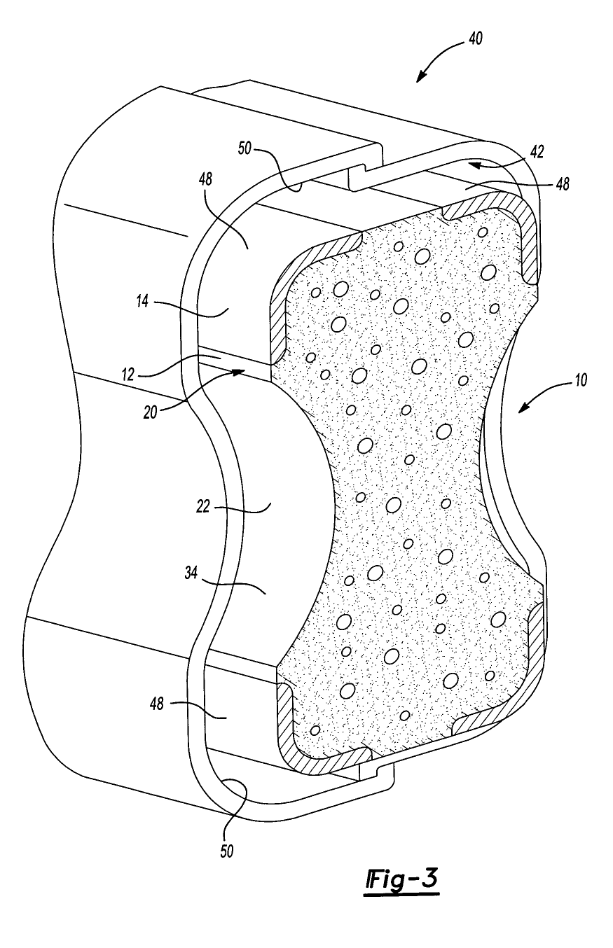

According to one exemplary embodiment shown in FIG. 3, there is illustrated the exemplary reinforcement member 10 that includes the carrier member 12 with the expandable material 14 disposed thereon. As shown, the reinforcement member 10 is suitable for placement adjacent to a structure 40 (e.g., a pillar structure) or within a cavity 42 of the structure 40, which is preferably a structure of an automotive vehicle. In the embodiment shown, the structure 40 has a cavity 42 corresponding to the configuration, particularly the outer surface 20, of the carrier member 12, the reinforcement member 10 or both. However, it shall be understood that the structure 40 may be formed in nearly any shape or configuration depending upon the intended use of the member 10 and depending upon other factors.

The carrier member 12, the reinforcement member 10 or both extend along an axis extending the length of the carrier member 12. The expandable material 14 in the particular embodiment illustrated is divided into multiple (e.g., four) masses 48 each disposed within one of the multiple cavities 28 of the carrier member 12 and extending lengthwise thereon.

The reinforcement member 10 may be inserted within the cavity 42 of the structure 40 in separate parts or as a unit. Upon insertion, the outer surface 20 of the carrier member 12, of the reinforcement member 10 or both are preferably adjacent and substantially opposing walls 50 defining the cavity 42, although not required. It should be understood that various supports or fasteners such as mechanical fasteners, adhesives, magnets, combinations thereof or the like, which may be integral with or attached to the reinforcement member and may be utilized to assist in locating the reinforcement member within the cavity at least until the expandable material is expanded and cured.

After insertion, the masses 48 of expandable material 14 are preferably activated as described herein to expand, contact and wet the walls 50 of the structure 40 and cure to adhere the reinforcement member 10, the carrier member 12 or both to the walls 50 of the structure 40 thereby forming a reinforced structural system. Advantageously, the reinforcement member 10 in this manner provides structural integrity to the structure 40 of the automotive vehicle.

In certain embodiments, it is contemplated that, prior to activation, measures may be taken to provide clearance between the reinforcement member and the walls of the structure into which the reinforcement member is placed. For example, the reinforcement member may be provided with spacers (e.g., small extensions), which are designed to maintain space between the walls and the reinforcement member prior to activation. Alternatively, portions of the expandable material may be placed or shaped such that those portions act as spacers. In this manner, e-coat can more easily coat the walls defining the cavity prior to activation of the expandable material.

In is also generally contemplated that the expandable material may be located upon the carrier member such that the carrier member and the walls of the cavity do not significantly contact each other. For example, the carrier may be substantially or fully encapsulated in the expandable material such that, upon activation, the expanded expandable material (i.e., the structural foam) provides a barrier between the carrier and the wall. Alternatively, the expandable material may be located such that, upon expansion, the expandable material spaces the carrier member away from the walls such that there is minimal contact therebetween. In this manner, any potential undesirable reactions (e.g., galvanic reactions or corrosive reactions), which might otherwise take place between the walls and the carrier, particularly when the walls and carrier are of dissimilar metals (e.g., where the structure is steel or ferrous and the carrier includes aluminum), can be avoided.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A process for reinforcing, sealing or baffling a structure of an article of manufacture, the process comprising:
forming a metal material into a carrier, the metal material including aluminum, magnesium or both, wherein the carrier includes:
i. an internal portion formed of a metallic foam having a density of less than about 0.7 grams/cm³; and
ii. an outer skin that is at least 0.7 mm thick, the outer skin substantially surrounding and enclosing the internal portion;
applying an expandable material upon the outer skin of the carrier to form a reinforcement member;
inserting the member within a cavity of the structure; and
activating the expandable material to expand, contact and wet internal walls of the structure defining the cavity and cure and adhere the member within cavity.

2. A process as in claim 1 wherein the structure is part of an automotive vehicle.

3. A process as in claim 1 wherein the forming of the metal material into a carrier includes casting of the metal material by placing pressure upon a bath of the metal material such that the metal material flows into a die cavity.

4. A process as in claim 1 wherein the metal material of the carrier is at least 85% metal.

5. A process as in claim 1 wherein the metal material includes metal matrix composite.

6. A process as in claim 1 wherein the forming of the metal material into a carrier is accomplished using low pressure aluminum casting.

7. A process as in claim 1 wherein at least 70% of the outer skin is at least 1.2 mm thick.

8. A process as in claim 1 wherein at least 90% of the outer skin is at least 2.0 mm thick.

9. A process as in claim 1 wherein the internal portion of the carrier has a density less than 0.5 g/cm².

10. A process as in claim 1 wherein the outer skin is roughened or textured for allowing the expandable material to adhere to a surface of the carrier with greater strength.

11. A process as in claim 1 wherein the shape of the carrier corresponds to the shape of the cavity of the structure.

12. A process for reinforcing, sealing or baffling a structure of an article of manufacture, the process comprising:
forming a metal material into a carrier having an internal cellular structure, the metal material including aluminum, magnesium or both, wherein the forming of the carrier includes:
i. extruding, casting or molding of the metal material in an at least partially molten state;
applying an expandable material upon the outer skin of the carrier to form a reinforcement member;
inserting the member within a cavity of the structure; and
activating the expandable material to expand, contact and wet internal walls of the structure defining the cavity and cure and adhere the member within cavity.

13. A process as in claim 12 wherein the structure is part of an automotive vehicle.

14. A process as in claim 12 wherein the forming of the metal material includes casting of the metal material by placing pressure upon a bath of the metal material such that the metal material flows into a cavity of a die.

15. A process as in claim 14 wherein the metal material flows through a riser tube into the cavity of the die and a gas is bubbled through the metal material and the metal material is cooled to form the internal cellular structure.

16. A process as in claim 15 wherein the die is at a first temperature and the metal material is at a second temperature as the metal material flows into the cavity of the die such that the carrier in formed with a relatively thick skin upon the outer periphery of the carrier and the internal cellular portion is substantially surrounded by the skin wherein the second temperature is at least 40% greater than the first temperature.

17. A process as in claim 16 wherein at least 70% of the skin is at least 0.7 mm thick.

18. A process as in claim 17 wherein the internal portion has a density less than 0.5 g/cm³.

19. A process as 17 further comprising roughening an outer surface of the skin of the carrier.

20. A process for reinforcing, sealing or baffling a structure of an automotive vehicle, the process comprising:
forming a metal material into a carrier having an internal cellular structure, the metal material including aluminum, wherein the forming of the carrier includes:
i. low pressure casting of the metal material in an at least partially molten state for forming the carrier with an outer skin of at least 2 mm thickness surrounding an internal cellular portion having a density of less than about 0.36 g/cm³;
applying an expandable material upon the outer skin of the carrier to form a reinforcement member;
inserting the member within a cavity of the structure of the automotive vehicle; and
activating the expandable material to expand, contact and wet internal walls of the structure defining the cavity and cure and adhere the member within cavity.
